(19) United States
(12) Patent Application Publication
(10) Pub. No.: US 2006/0188857 A1
(43) Pub. Date: Aug. 24, 2006

(54) Self-awareness training method and apparatus

(76) Inventors: John Marett Knowles, Paphos (CY); Linda Anne LeBlanc, Paphos (CY)

Correspondence Address: SHUGHART THOMSON & KILROY, PC, 120 WEST 12TH STREET, KANSAS CITY, MO, 64105, US

(21) Appl. No.: 11/060,821

(22) Filed: Feb. 18, 2005

(51) Int. Cl. G09B 19/00

(52) U.S. Cl. 434/236

(57) ABSTRACT

Apparatus for use in personal awareness training, comprising: a plurality of coded card sets, each card set having a generic indicia associated with it, the cards in a set having a common theme.

The present invention relates to the field of self-awareness training, and provides apparatus, and a training method, for enhanced self-awareness, including awareness of past life experiences. The present invention is a psychological research tool intended for the lay user. Its purpose is to enable the individual who is interested in the reincarnation phenomenon to evoke incidents, so-called “far memories”, from other embodiments, in the form of intuitions, from his or her higher consciousness. The user alone is involved as the sole participant, although he or she may also choose to use these cards in collaboration with a professional past-life therapist or researcher.

The present invention includes the “Reincarnation” cards that are designed to awaken the user's own intuition, to allow his or her conscious mind in present-day reality to obtain access to knowledge that is already full and complete in the deeper and higher levels of consciousness. This process stimulates the emergence into conscious awareness of “far memory” of events that were once directly known and experienced, but have since been simply forgotten. This forgetfulness is thought to be caused by the overwhelming screening influence of the gestation period, the birth trauma, early environmental circumstances, including parental suppression, and subsequent conventional education, with its emphasis on a reductionist, dualistic materialism.

The user is provided with full instructions on how the cards are to be most effectively utilized in the effort to recover this lost knowledge. He or she is also furnished with a comprehensive list of recommended books on the subject, for deeper study.

This invention comprises a set of cards uniquely designed to awaken the user's own “far memory”, i.e., buried memories of past (and indeed future) incarnations. The cards may be used by any person who has an interest in recalling details of his or her other individual embodiments, as an “aide mémoiré” for the user. Normally, no other person is involved, although the user may choose to employ the cards in collaboration with a professional such as a past-life therapist, a psychiatrist, or a clinical psychologist, many of whom have learned by experience with their clients that reincarnation may be factual.

Although optional, it is recommended that the cards be used in conjunction with a user-supplied looseleaf notebook and a pendulum. An important use of the pendulum in conjunction with the cards is to verify the accuracy of an interpretation of any given intuition. A pendulum is quite easy to use. It may be bought commercially or a person may make their own, with nothing more complicated than a six-to-eight inch thread or string, from which you suspend a small weight, like a ring or a key. Seated at a table, both feet on the floor (uncrossed ankles), a user rests an elbow on the table and suspends the pendulum from the hand. Trying not to move it by any conscious action of their own, questions are posed to one's higher consciousness to show one what the pendulum will do if one asks it a “Yes” or “No” question. “Yes” may be indicated by the pendulum moving in a clockwise circle, and “No” by moving counter-clockwise. Alternatively, “Yes” may be by either type of circle, and “No” by a diagonal movement of the pendulum, or vice versa. With practice, one will settle on what is the correct procedure for that person, and can then ask it only questions that can be answered by “Yes” or “No”. It will be understood, moreover, that the pendulum is not the entity answering the question, it is the higher consciousness, using the pendulum. Without such aids, however, the cards will still evoke far memories, but these tend, like dreams, to be lost if not methodically recorded. A looseleaf notebook is recommended, as it will enable the user the more readily to group impressions received at different times, of what appear to be the same lifetime's experiences together for analysis and eventual construction of a more or less complete picture of each such incarnation. The pendulum is useful as a cross-check to validate such intuitions as genuine.

In a broad aspect, then, the present invention relates to apparatus for use in personal awareness training, comprising: a plurality of coded card sets, each card set having a generic indicia associated with it, the cards in a set having a common theme.

The indicia are preferably selected from the group consisting of colours, words, symbols, or graphical images.

The themes of the card sets are themes relevant to life experiences.

Each set has from 9 to 17 cards, in a preferred embodiment.

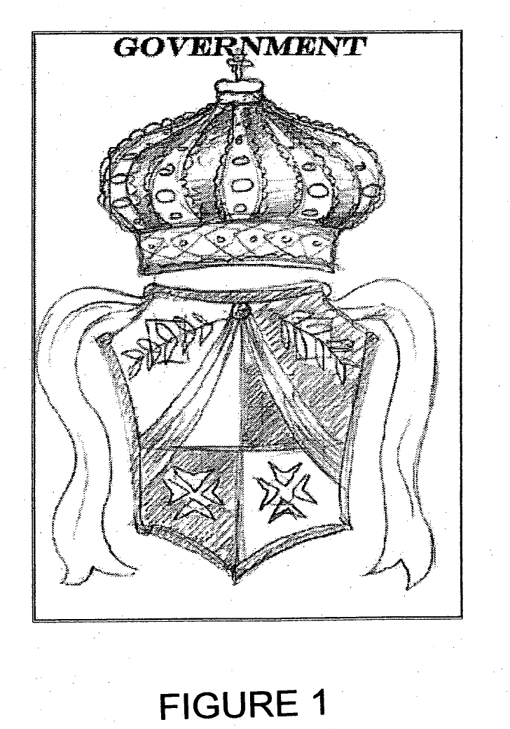

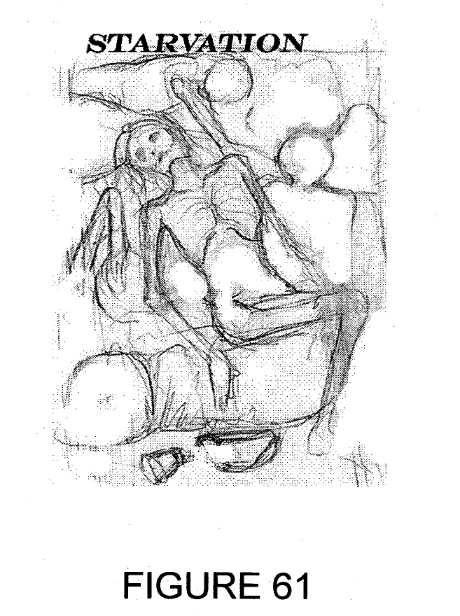

The accompanying drawings, FIGS. 1 to 61, illustrate a set of reincarnation cards in accordance with the present invention.

The “Reincarnation Cards”

The cards comprise five (5) sets, in “Categories”. Each set may be color-coded. The categories and their suggested color codes are set out below:

| Category | Color | Number of Cards |
|---|---|---|
| Occupation | White | 14 |
| Culture | Royal Blue | 17 |
| Environment | Green | 9 |
| Theme | Red | 11 |
| Termination | Purple | 10 |

| | |
|---|---|
| Total | 61 |

These categories are broken down into sub-categories as set out hereunder. On the face of each card is drawn a picture and/or a symbol indicative of some known aspect or aspects of the sub-category listed.

I. White (14) Occupation

FIG. 1 Government

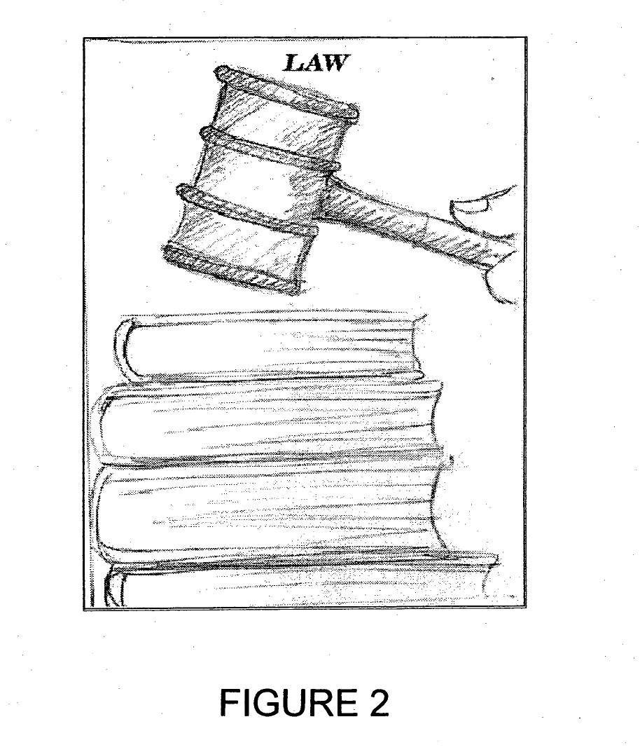

FIG. 2 Law

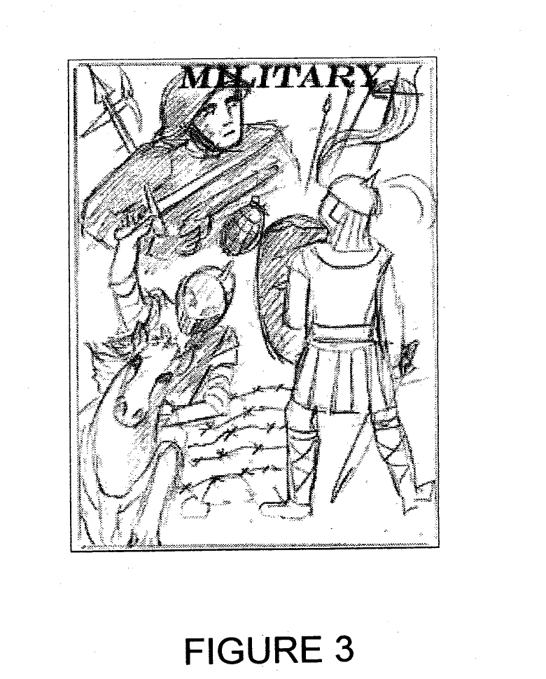

FIG. 3 Military

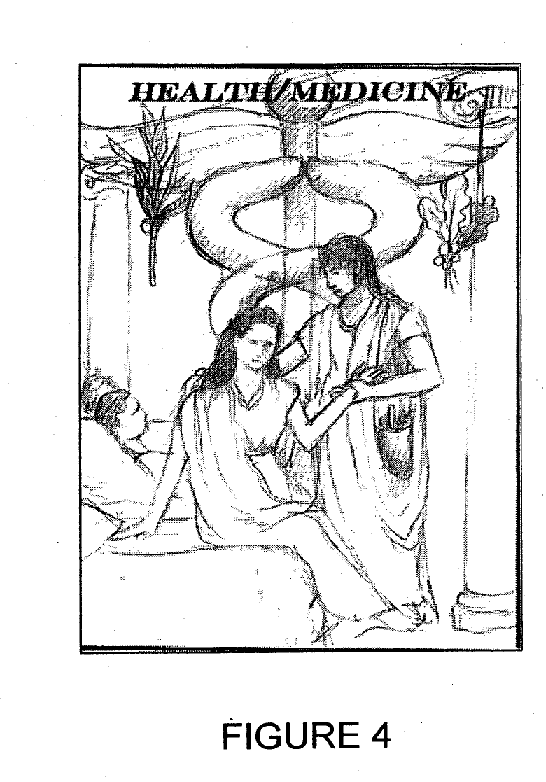

FIG. 4 Health/Medicine

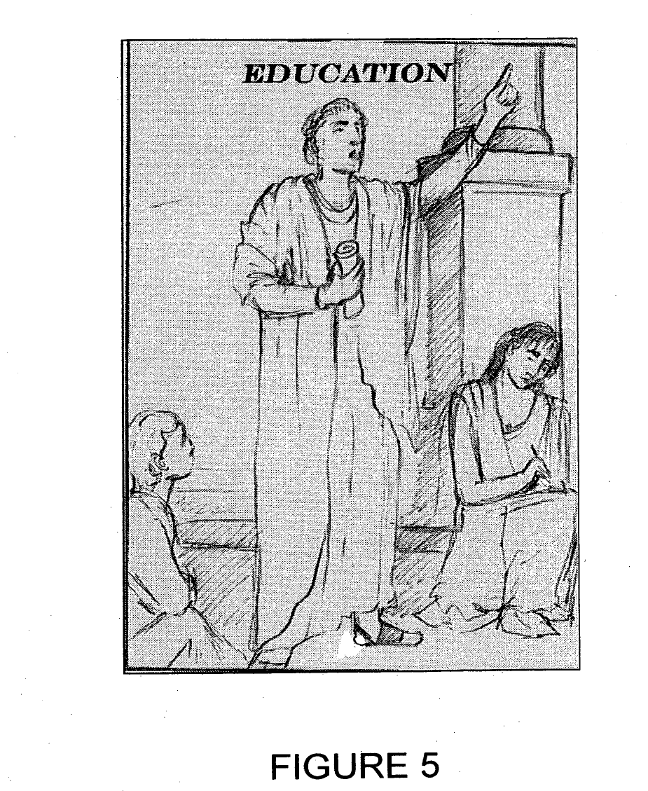

FIG. 5 Education

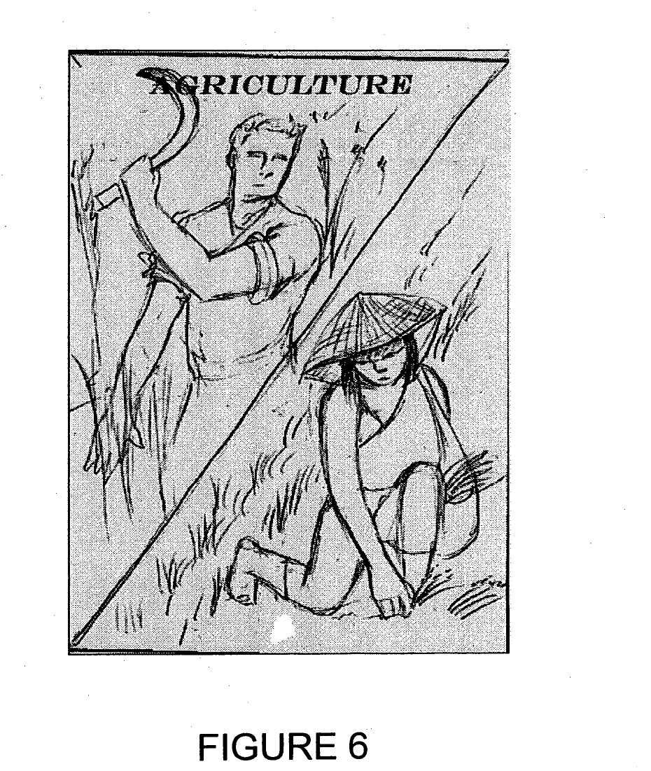

FIG. 6 Agriculture

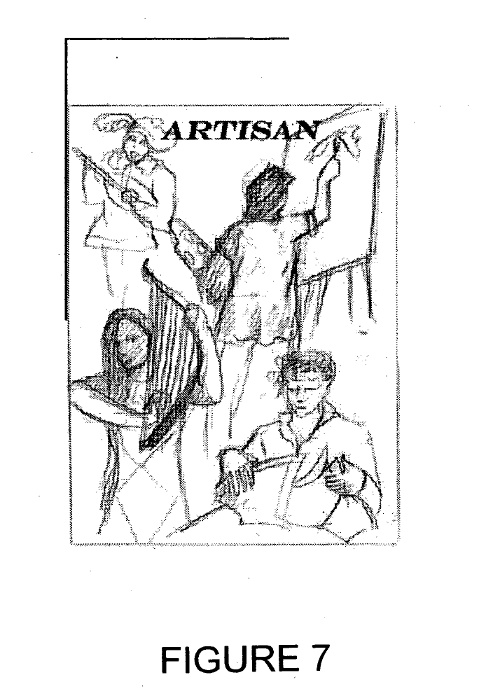

FIG. 7 Artisan

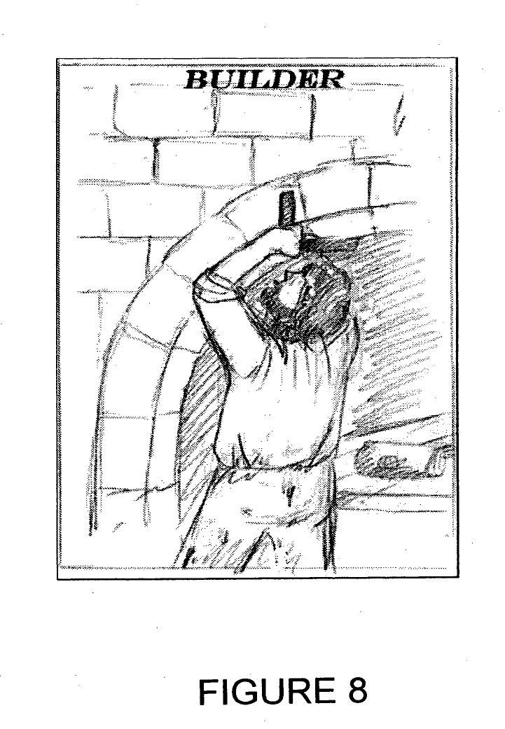

FIG. 8 Builder

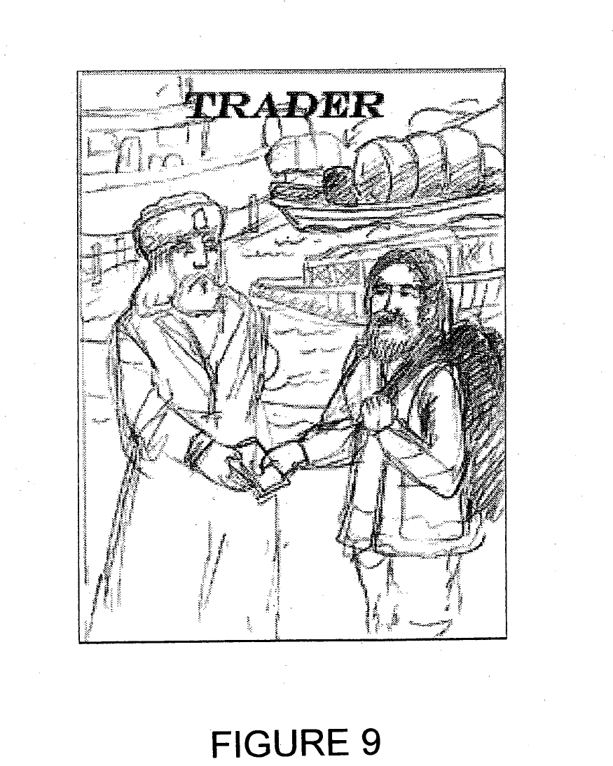

FIG. 9 Trader

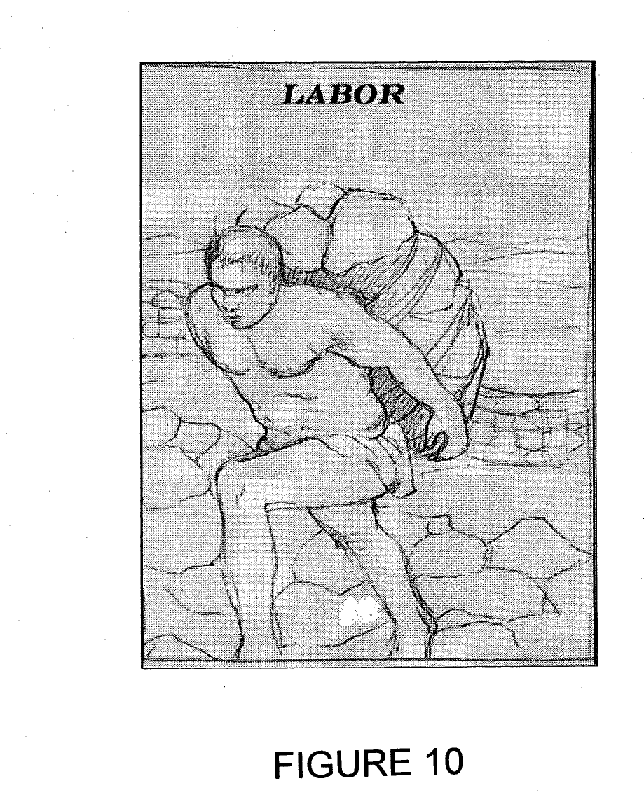

FIG. 10 Labor

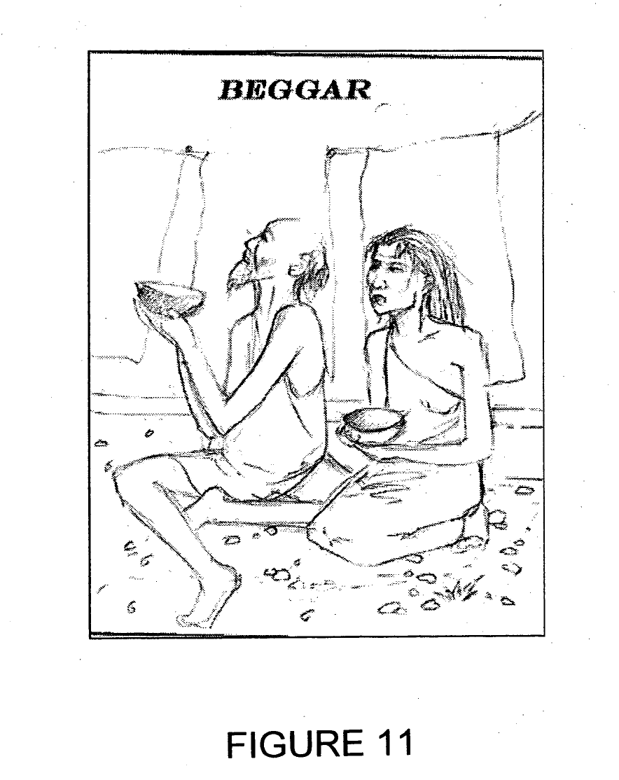

FIG. 11 Beggar

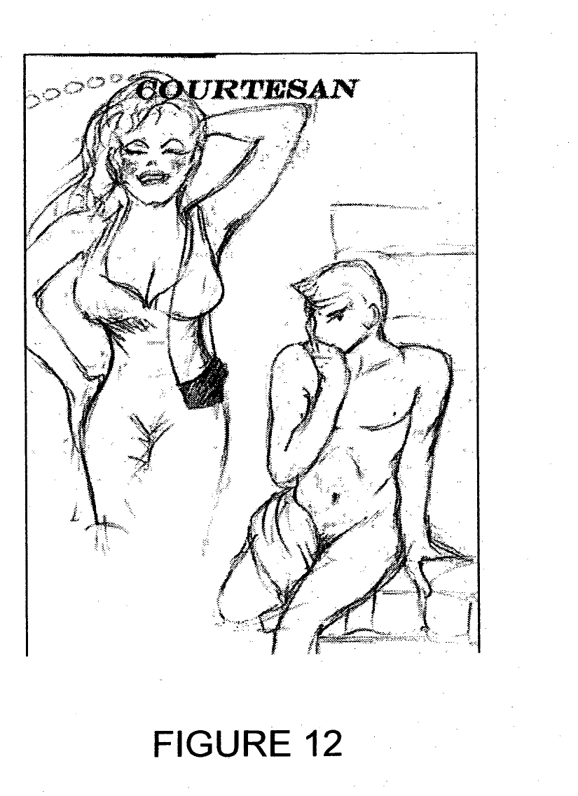

FIG. 12 Courtesan

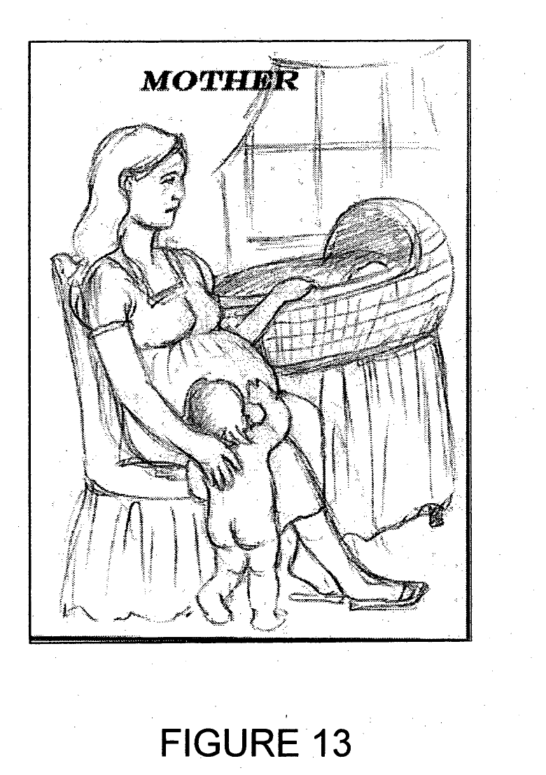

FIG. 13 Mother

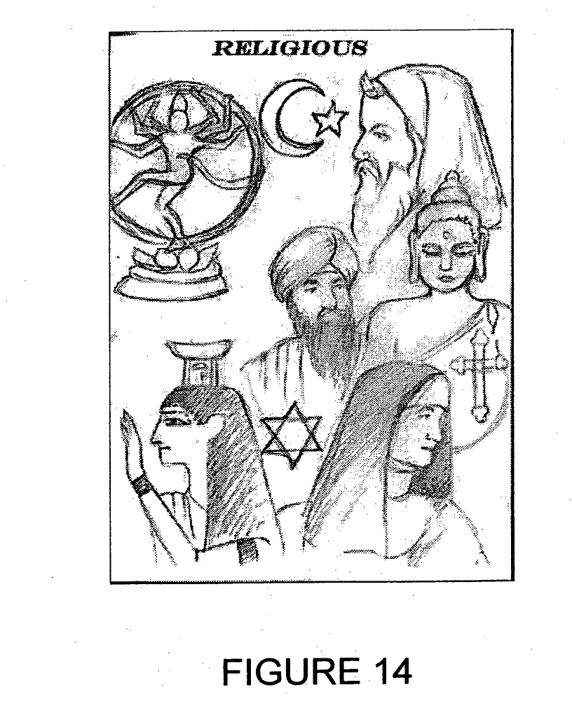

FIG. 14 Religious

II Royal Blue Cards (17) Culture

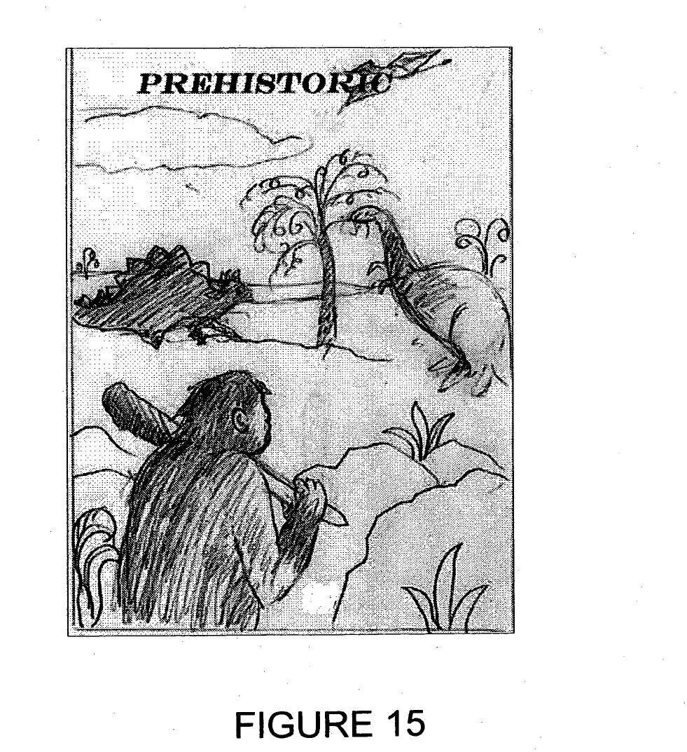

FIG. 15 Prehistoric

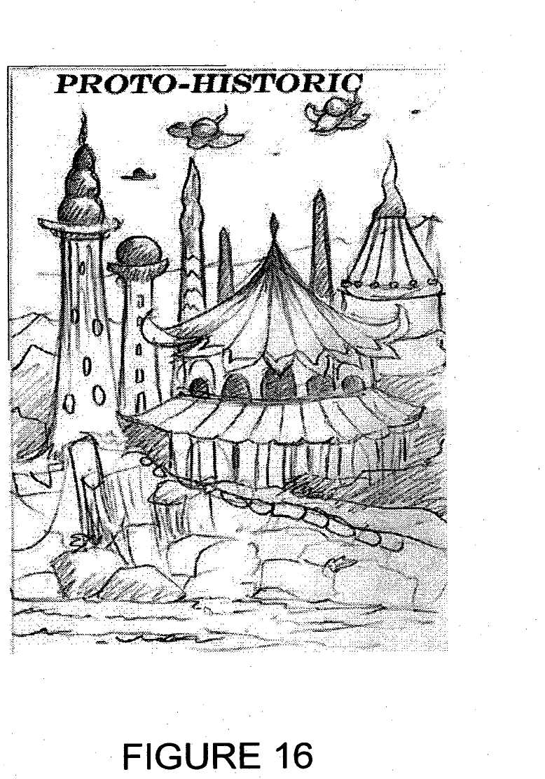

FIG. 16 Proto-historic

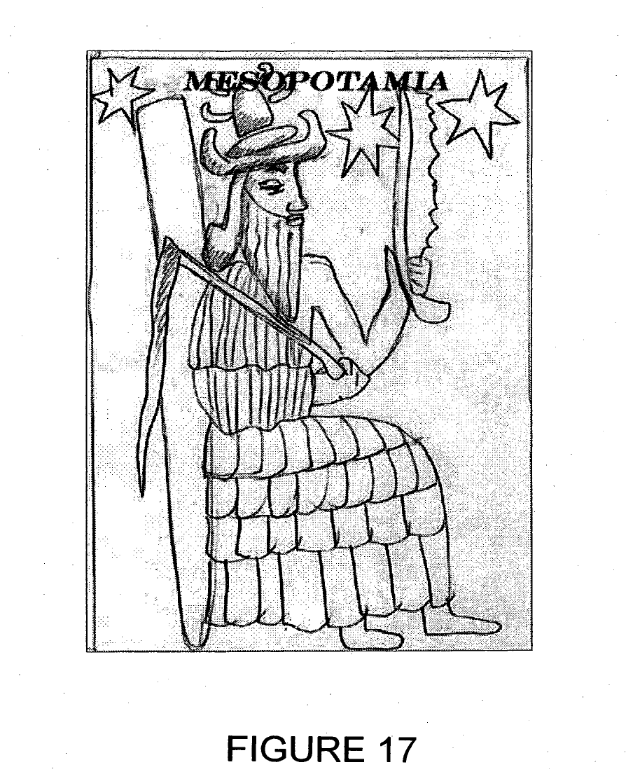

FIG. 17 Mesopotamia

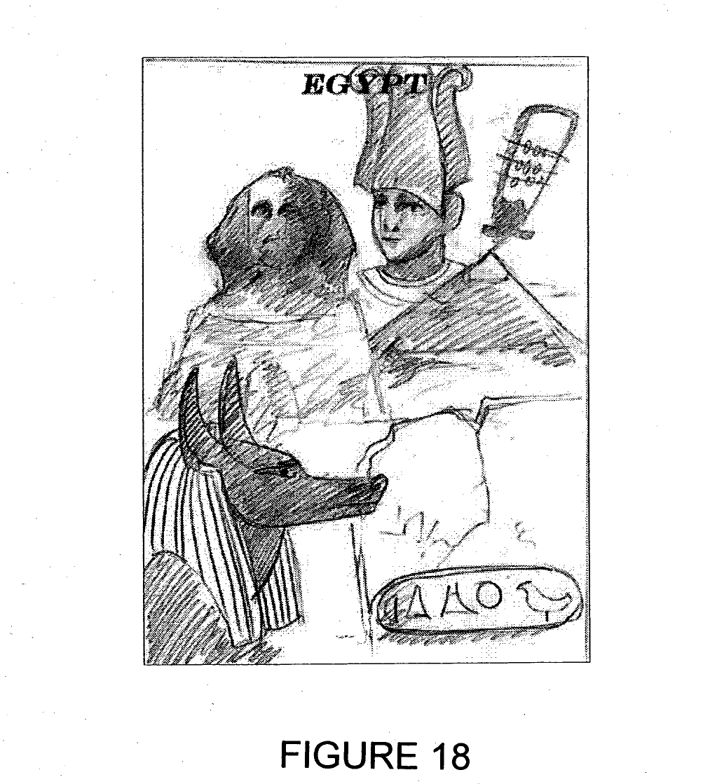

FIG. 18 Egypt

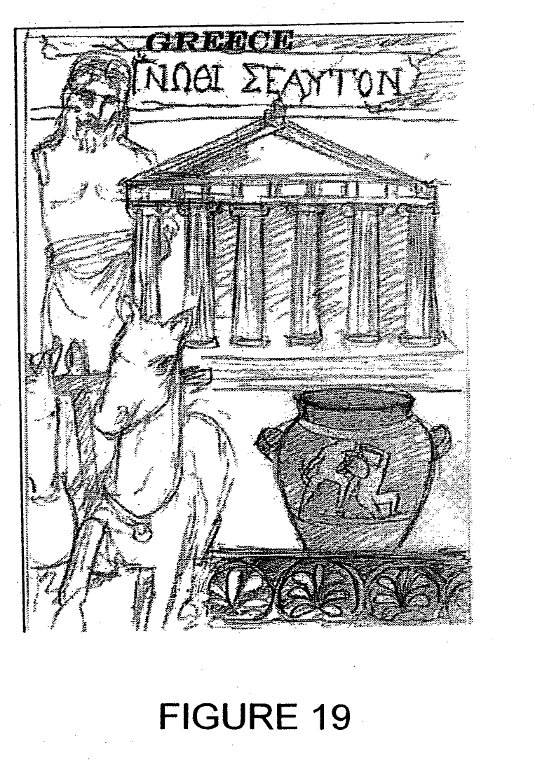

FIG. 19 Greece

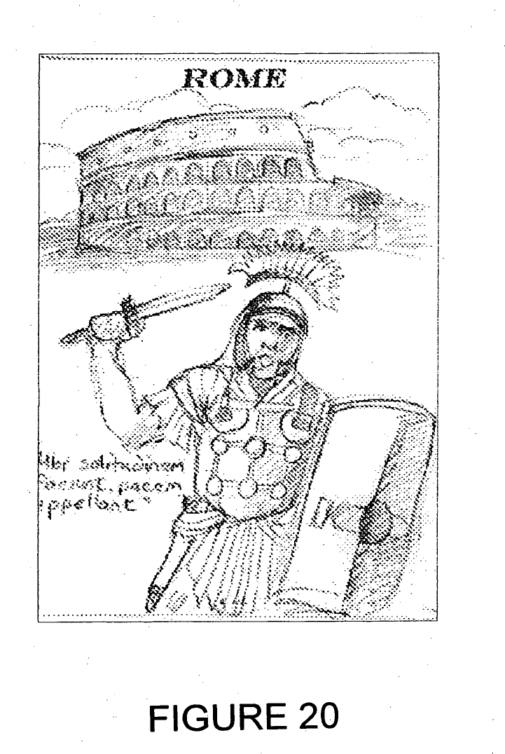

FIG. 20 Rome

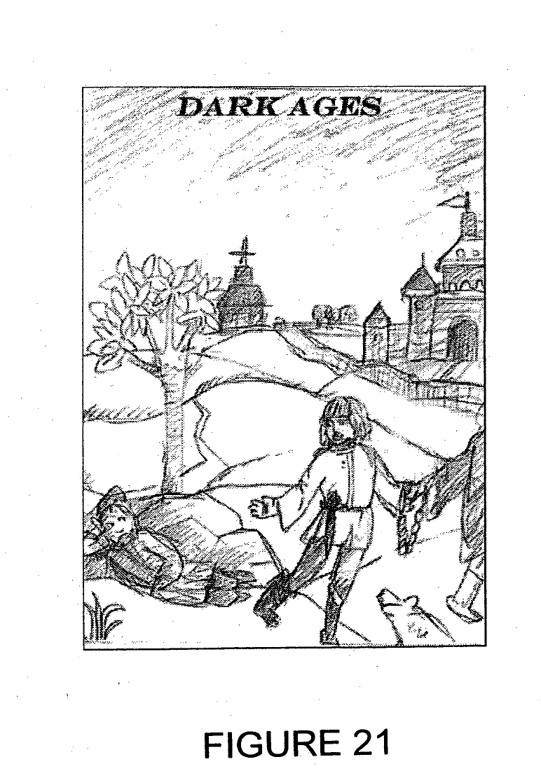

FIG. 21 Dark Ages

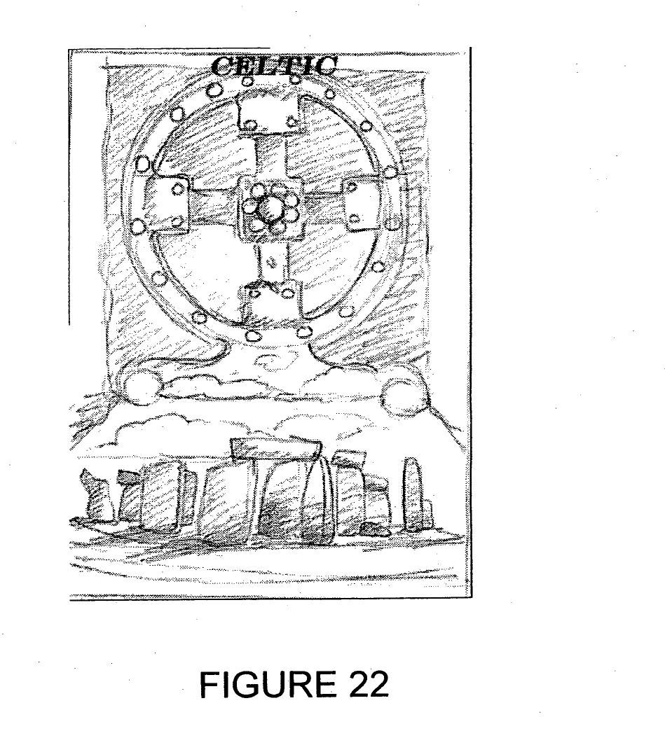

FIG. 22 Celtic

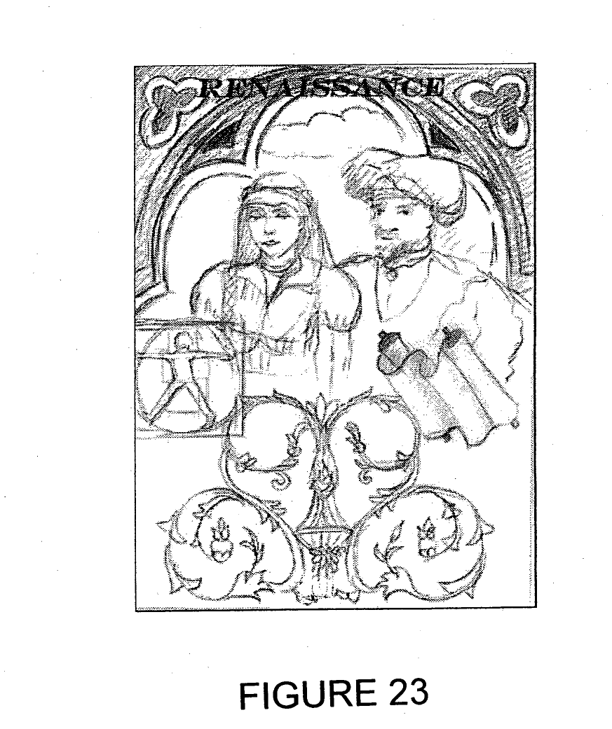

FIG. 23 Renaissance

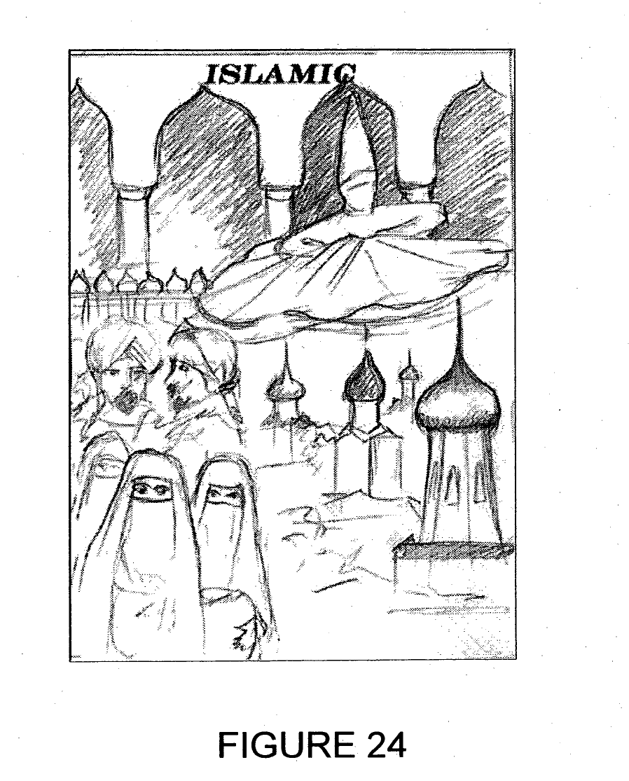

FIG. 24 Islamic

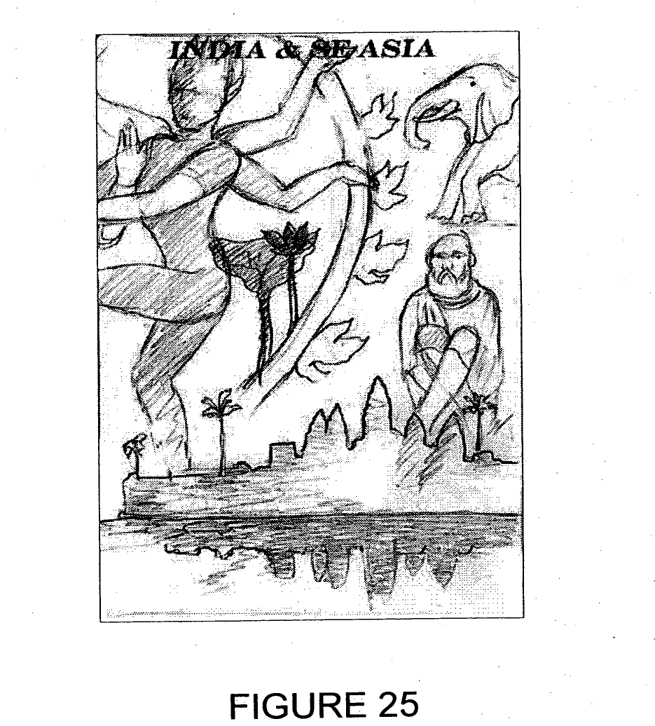

FIG. 25 India and Southeast Asia

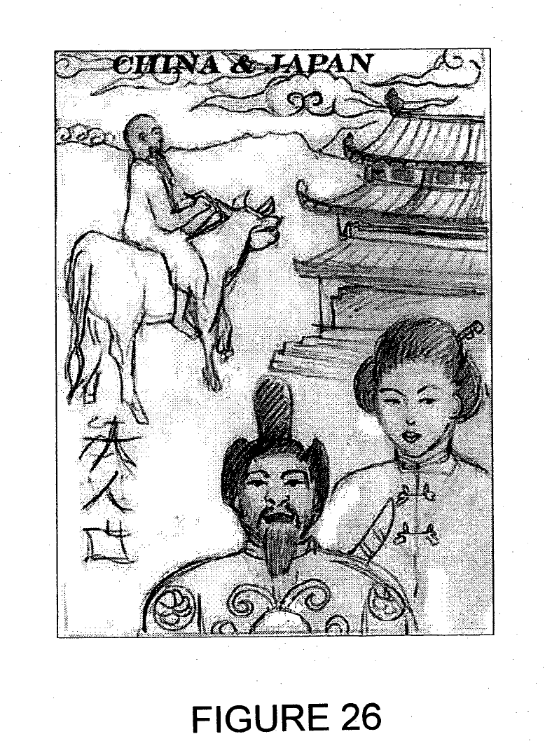

FIG. 26 China and Japan

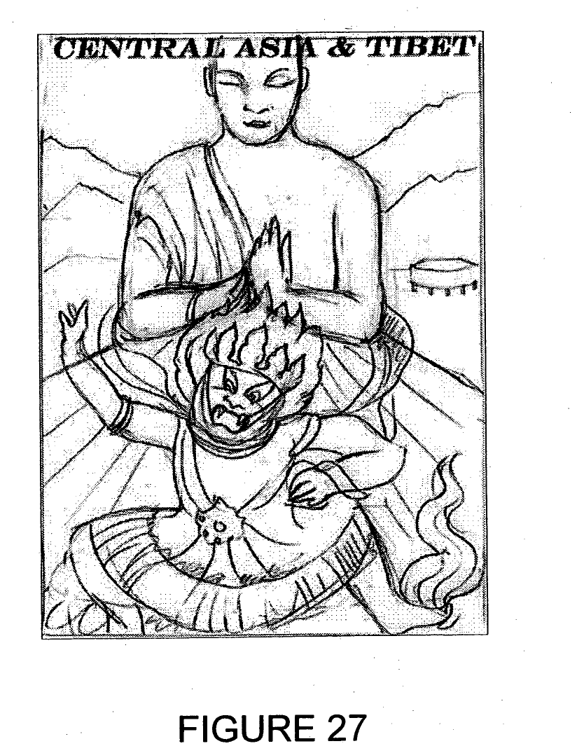

FIG. 27 Central Asia and Tibet

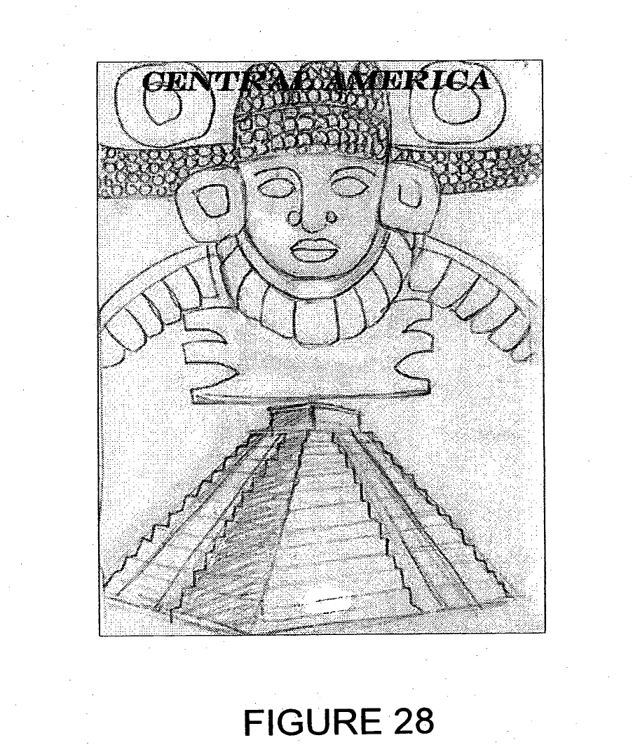

FIG. 28 Central America

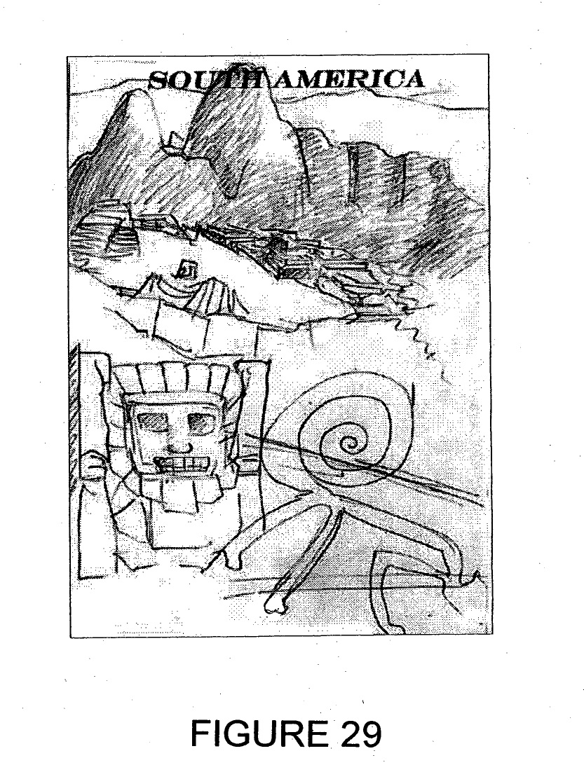

FIG. 29 South America

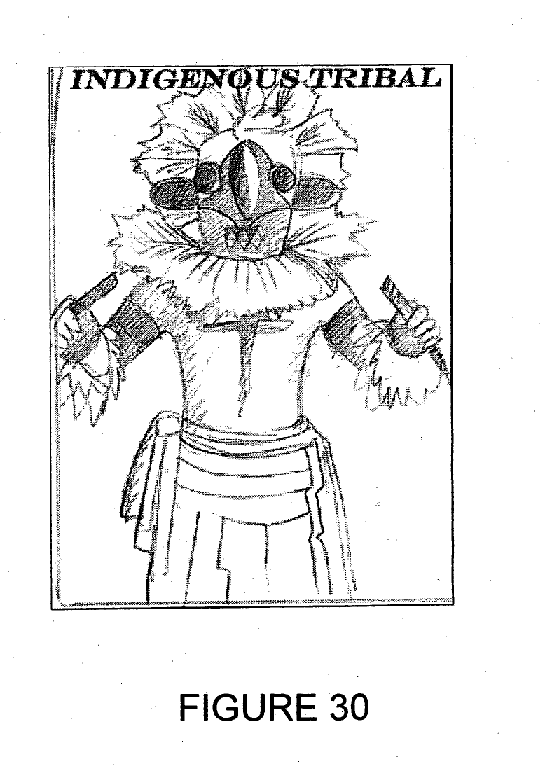

FIG. 30 Indigenous Tribal

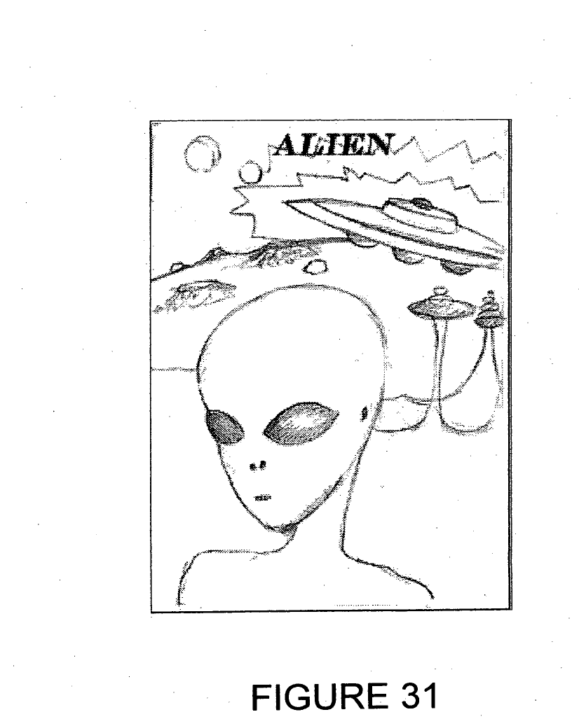

FIG. 31 Alien

III Green cards (9) Environment

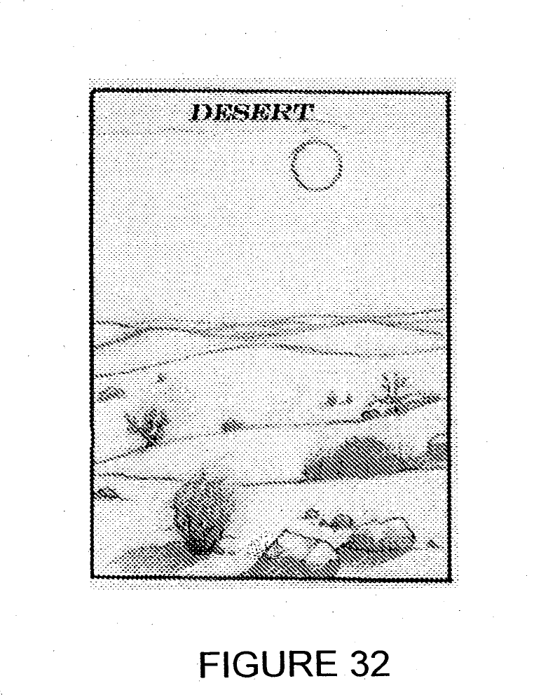

FIG. 32 Desert

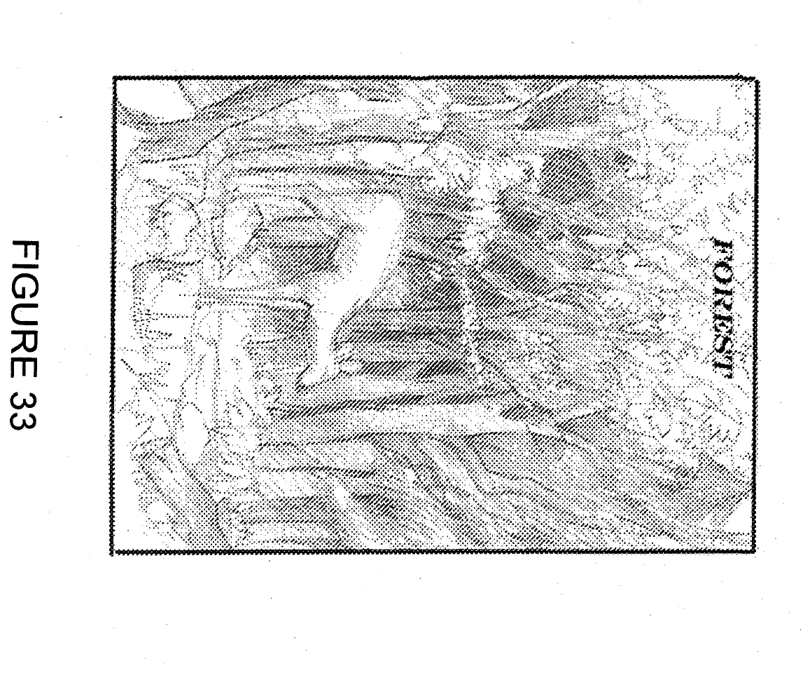

FIG. 33 Forest

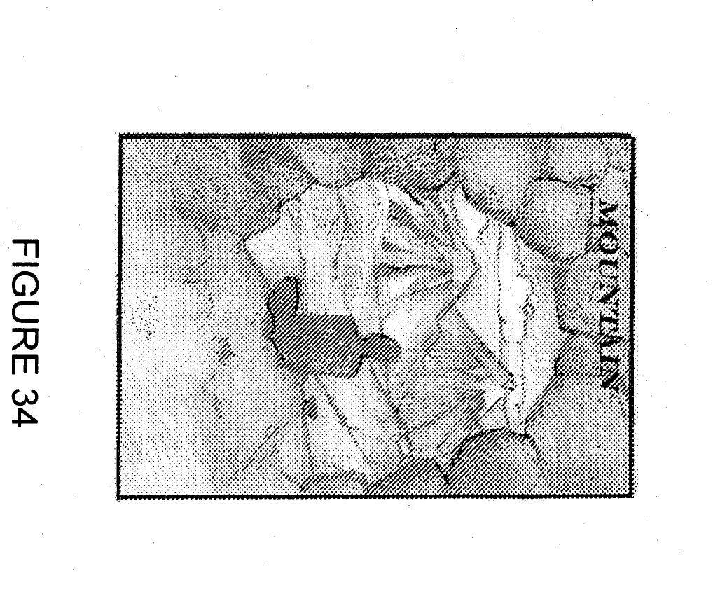

FIG. 34 Mountain

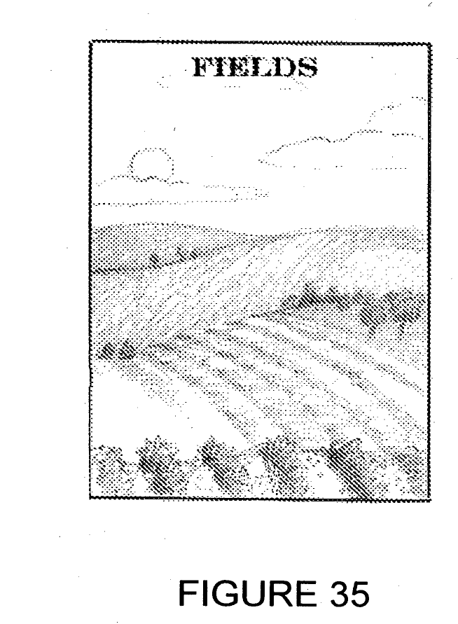

FIG. 35 Fields

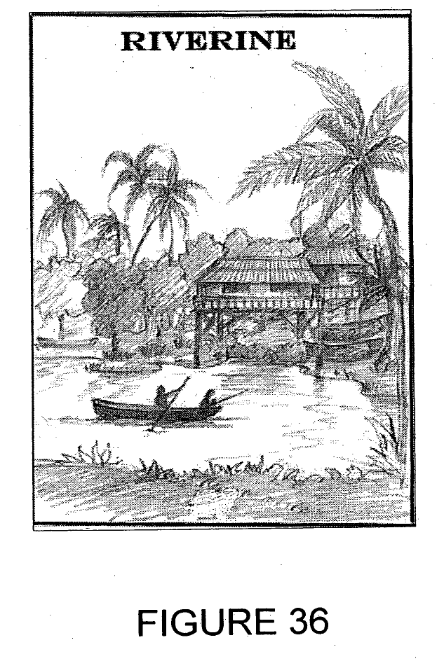

FIG. 36 Riverine

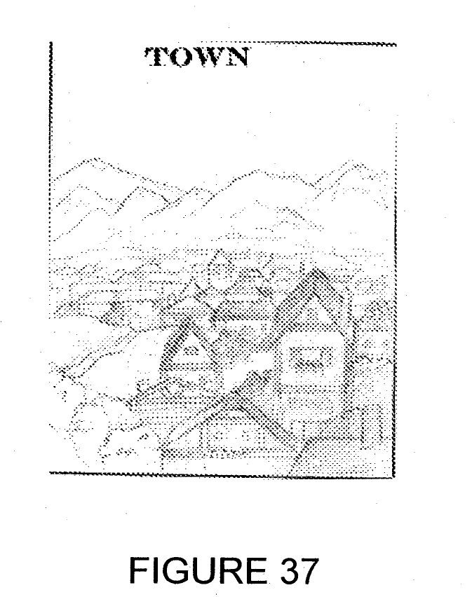

FIG. 37 Town

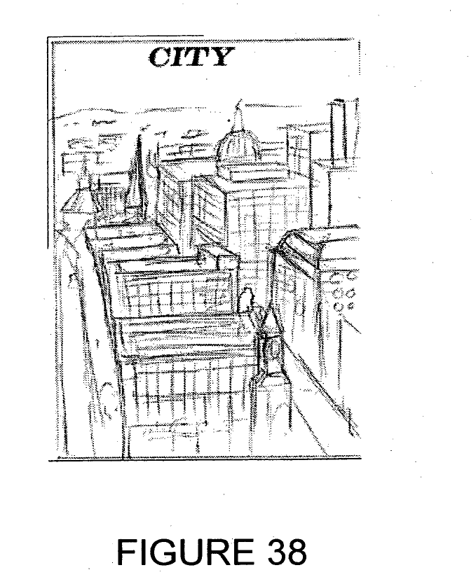

FIG. 38 City

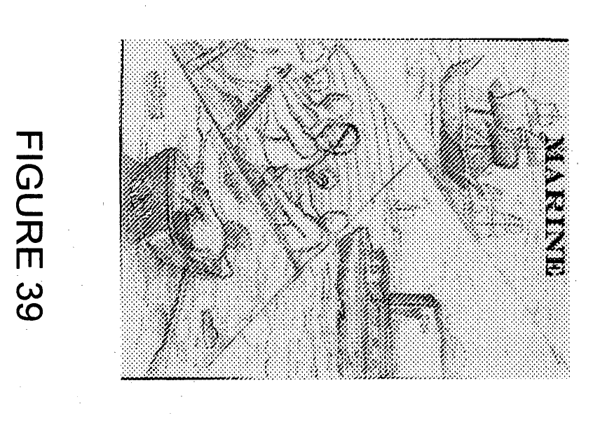

FIG. 39 Marine

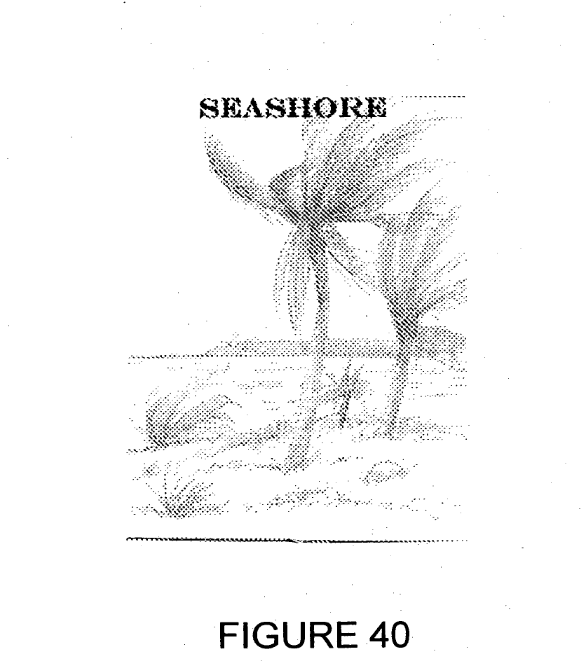

FIG. 40 Seashore

IV Red Cards (11) “Theme”

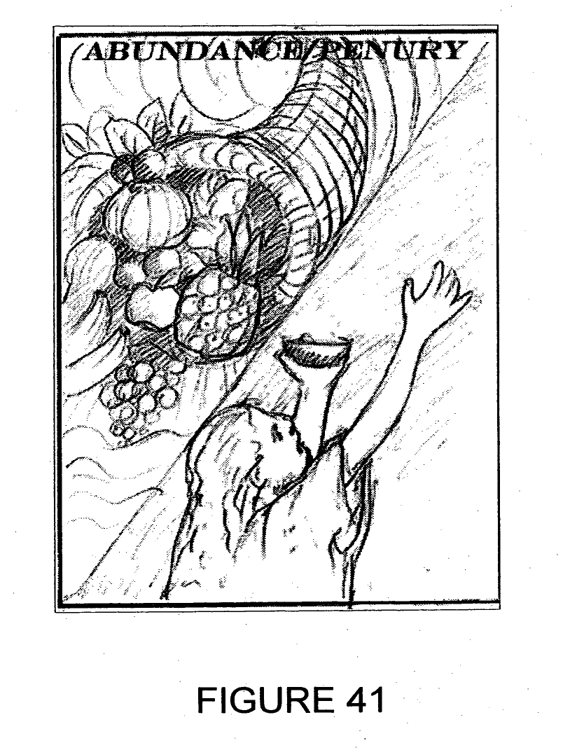

FIG. 41 Abundance/Penury

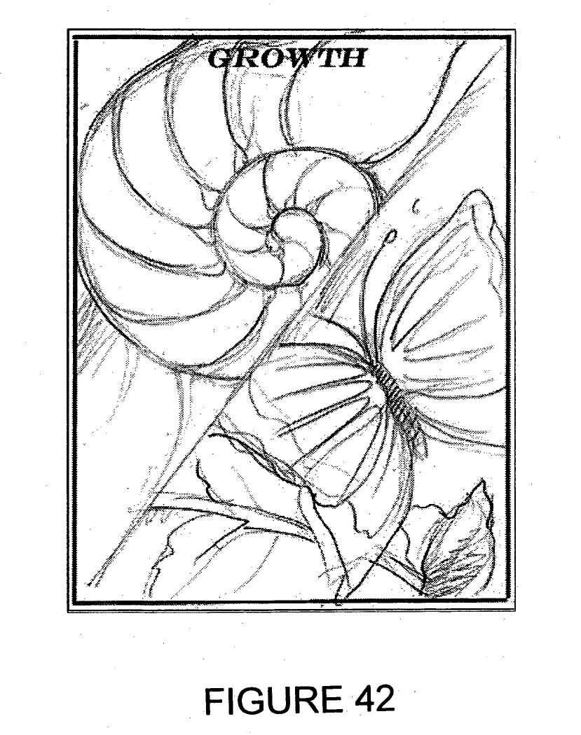

FIG. 42 Growth

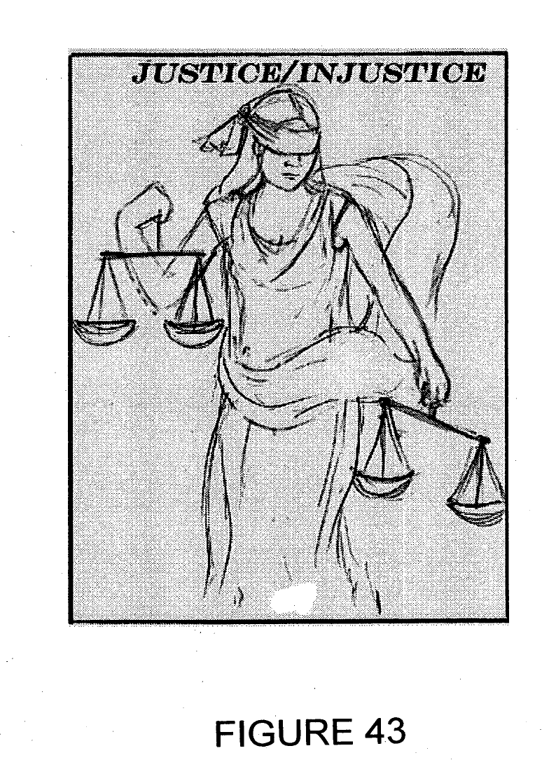

FIG. 43 Justice/Injustice

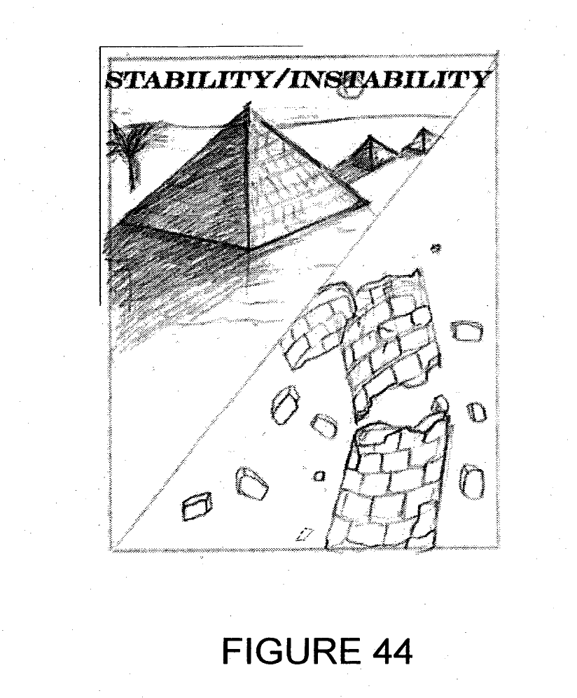

FIG. 44 Stability/Instability

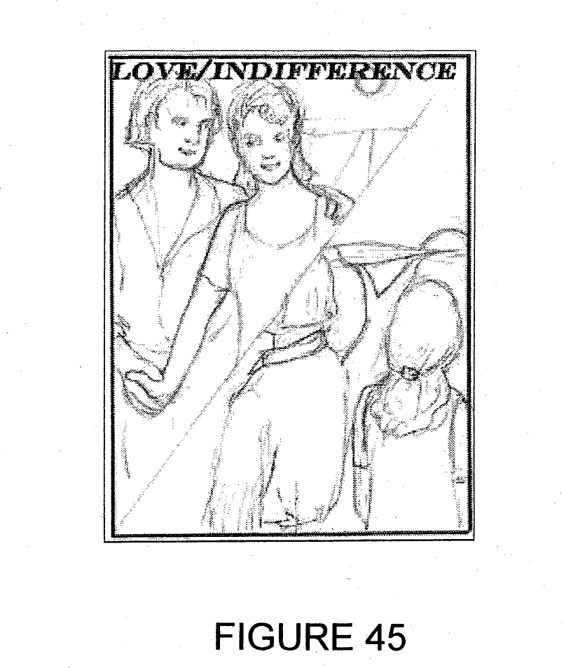

FIG. 45 Love/Indifference

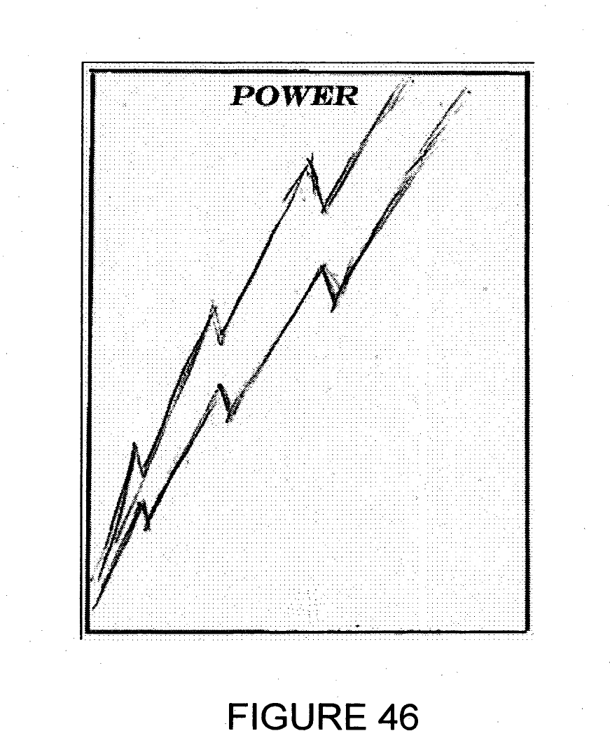

FIG. 46 Power

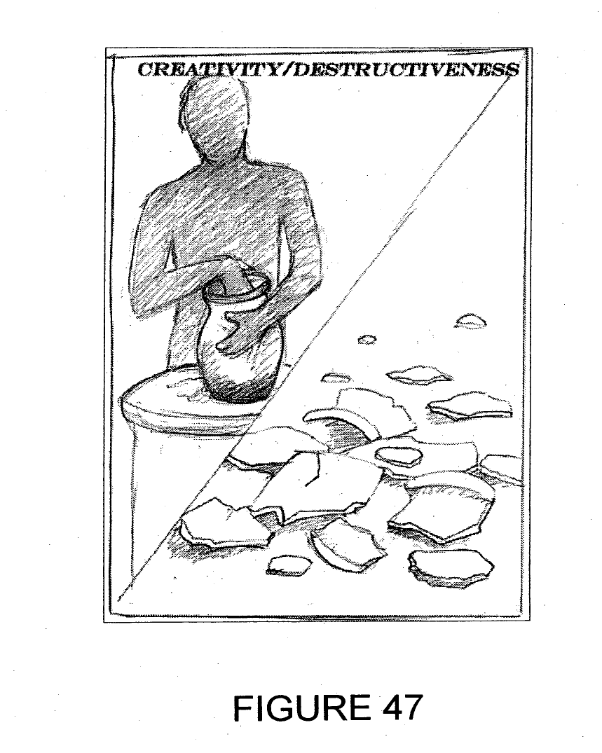

FIG. 47 Creativity/Destructiveness

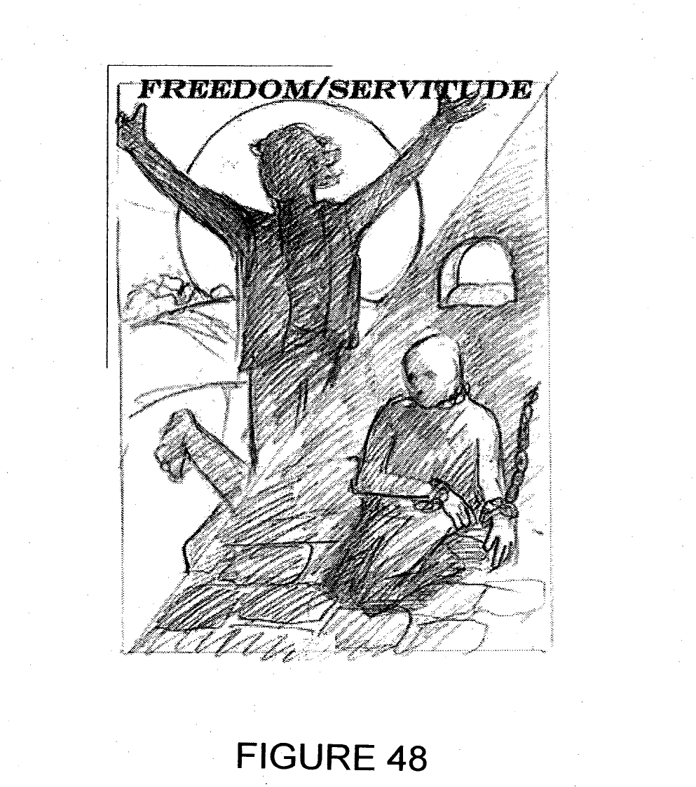

FIG. 48 Freedom/Servitude

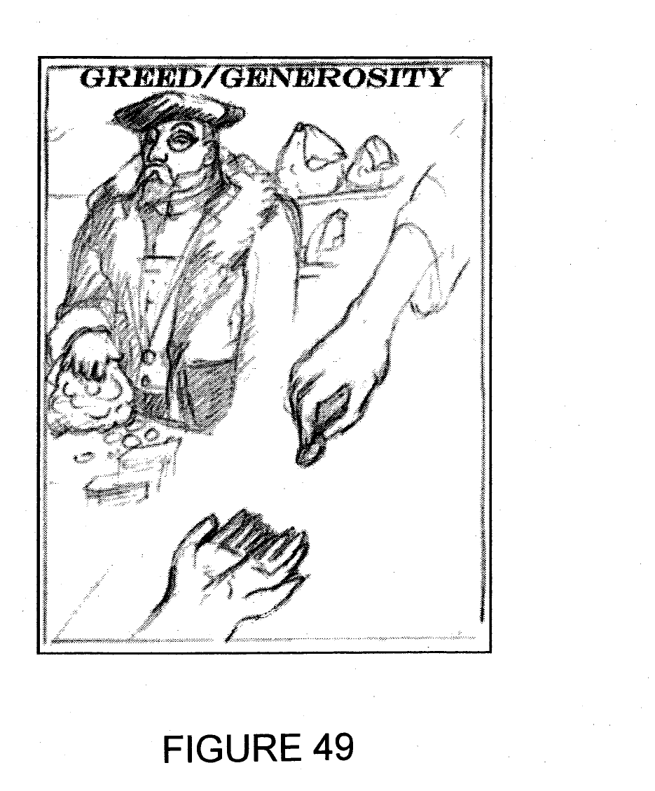

FIG. 49 Greed/Generosity

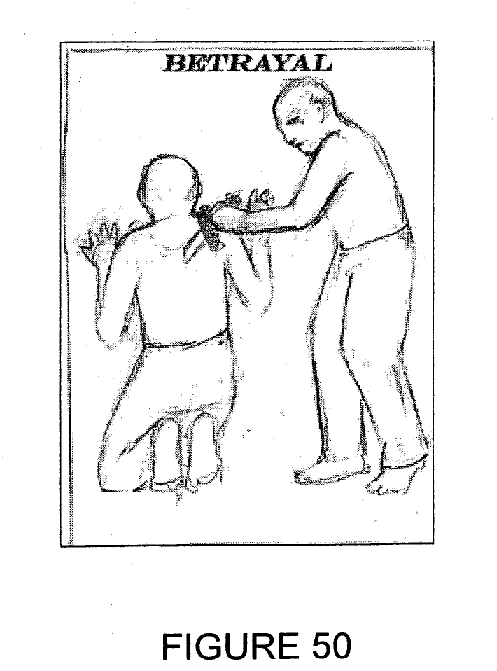

FIG. 50 Betrayal

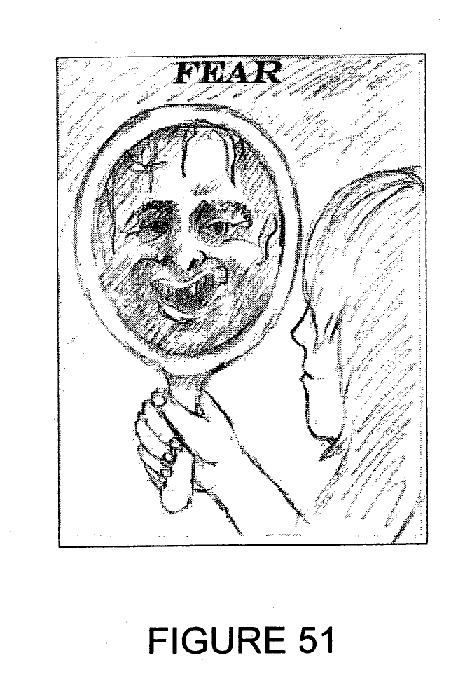

FIG. 51 Fear

V Purple Cards (10) Termination

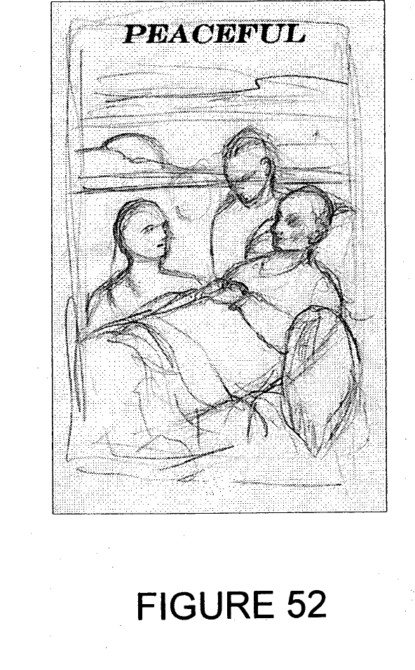

FIG. 52 Peaceful

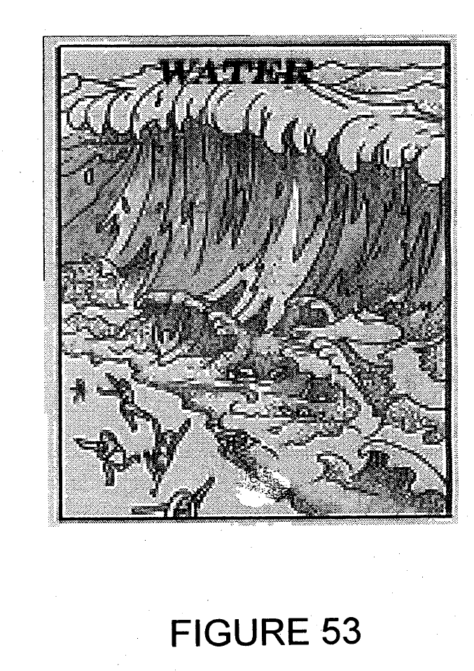

FIG. 53 Water

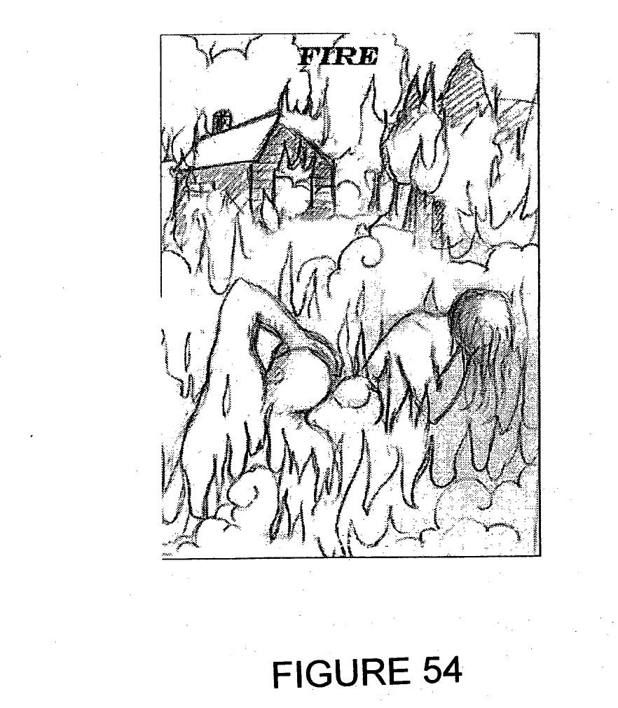

FIG. 54 Fire

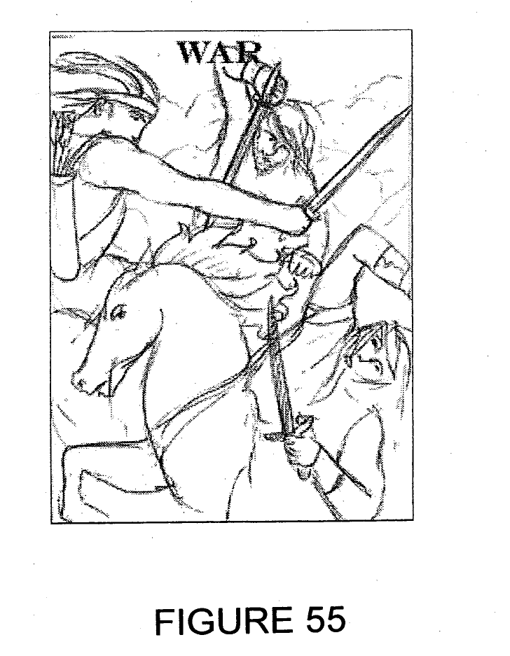

FIG. 55 War

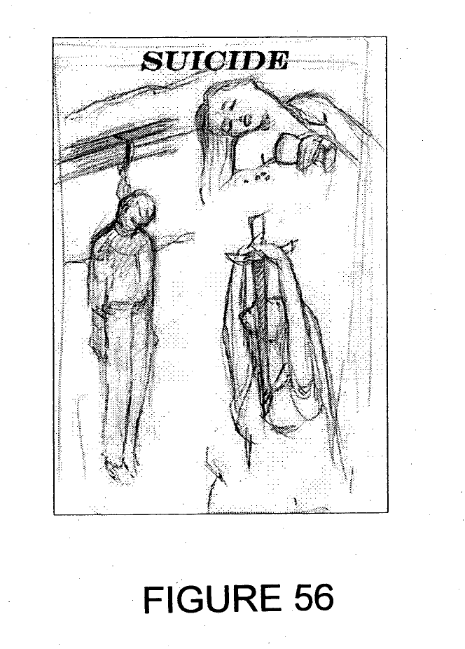

FIG. 56 Suicide

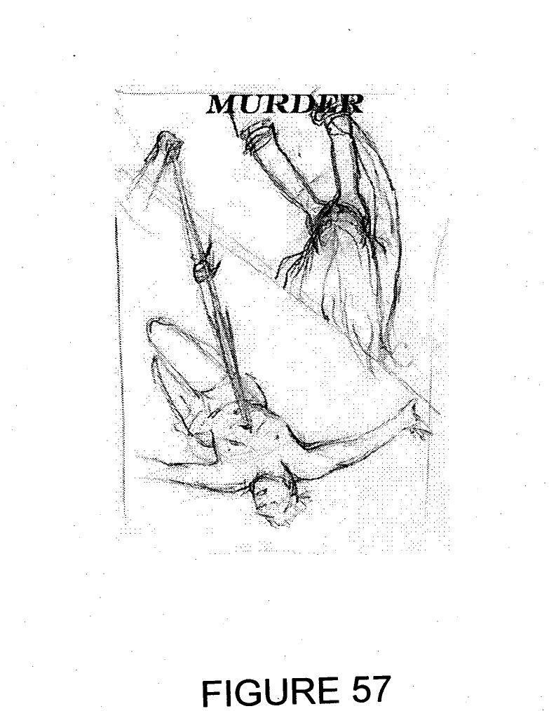

FIG. 57 Murder

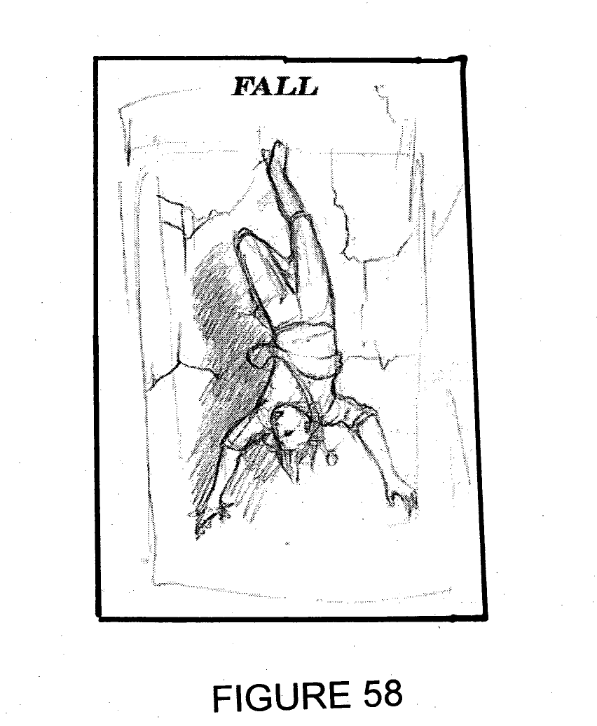

FIG. 58 Fall

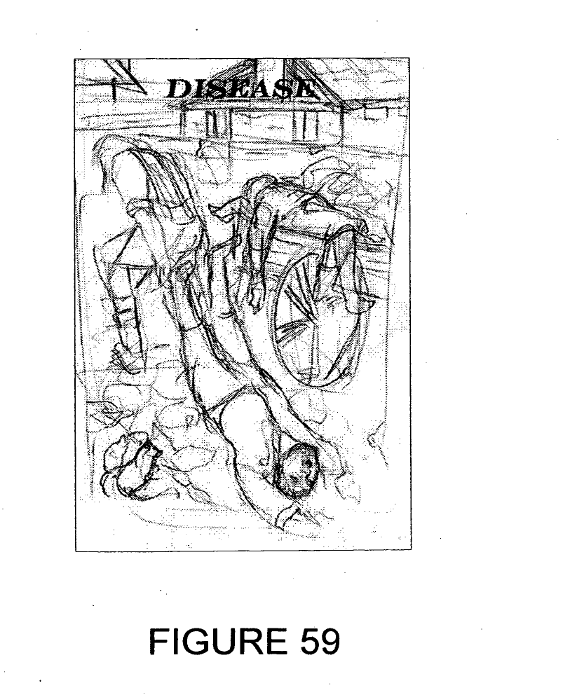

FIG. 59 Disease

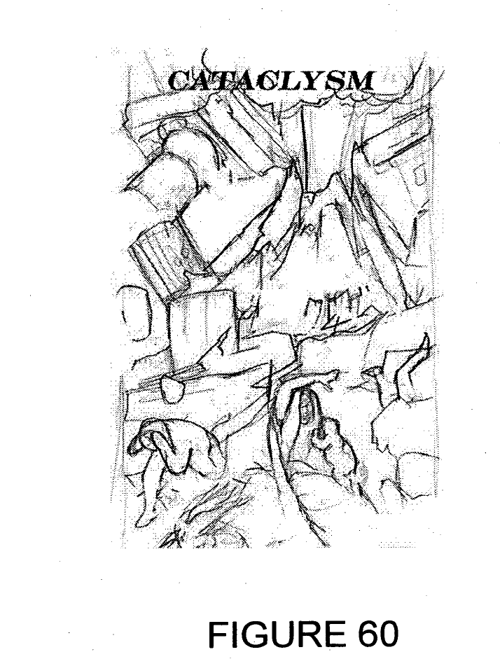

FIG. 60 Cataclysm

FIG. 61 Starvation

/*

The cards are used in the following way:

The user, after focussing on his or her intention, quietening his or her own mind, and asking his or her higher self for guidance, would thoroughly shuffle and spread out all 61 cards on a table, in a fan or fans, face down, and select one of each of the five colors. These would then be turned over and studied, one by one, with a note being made of any evoked intuitions, to be recorded in a cumulative, looseleaf journal. The user is encouraged to pay repeated, close attention to any such intuitions that surface from the higher reaches of consciousness. These can take the form immediately, or later, of memory “flash-backs” and déjà-vu experiences while in the waking state, as well as in both ordinary and lucid dreams, that relate to episodes experienced in other lives. As the user becomes increasingly familiar with these phenomena, he or she becomes ever more convinced of their actuality and accordingly stimulates more and more of them. Putting these together in the looseleaf journal, over time, will eventually enable the user to reconstruct, as it were, more or less complete lifetimes' experiences.

A list of recommended books is included in the “Book of Karma”, i.e., the book containing information for the user on the cards, their purpose, use, and the underlying philosophy of the system. Those who seriously study the subject will much more readily stimulate such “far” memories.

The cards and associated “Book” have as their purpose to awaken generally the intuition of the enquirer, leading eventually to the perception of what is ultimately real, behind all such phenomena. This entails the understanding that the truly enlightened “individual” is essentially identical to the One Cosmic Self, and is, therefore, incarnate in all things, in all times and in all places, simultaneously.

From this standpoint it may be understood that all births, deaths, personalities and “incarnations” are transient phenomena of no ultimate significance in and of themselves.

This invention, and underlying concept are based on two propositions:

(a) The most recent, pioneering scientific research seems to indicate that the reincarnation experience is a fact. The research of Dr. Ian Stevenson, recently retired Carlson Professor of Psychiatry at the University of Virginia Medical School, conducted in accord with the strictest scientific protocol, appears to have demonstrated beyond all reasonable doubt that reincarnated individuals can, and often do, carry over into the new incarnation actual physical evidence of traumas suffered in or other signs related to immediately preceding embodiments. (Stevenson 1997). This solid physical evidence convincingly rebuts the objections raised by sceptics, who heretofore have usually dismissed valid memories of other incarnations as mere “anecdote”, hence unworthy of serious consideration.

(b) The basic principle in Physics that all existence, i.e., the universe, is by definition, one. Monism, be it “material” or “mental” is logically unassailable. It must be one or the other. Research into the nature of “matter” over the past century, however, strongly reinforces the mental monist view that consciousness is all—that “matter”, as such, is illusory. Bell's determination of non-locality in a superluminal universe, which implies universal simultaneity (i.e., everything is really happening at once), supports this view. Accepting the 1918 Nobel Prize for Physics, the father of quantum physics, Max Planck, declared, “There is no matter as such! All matter originates and exists only by virtue of a force . . . We must assume behind this force the existence of a conscious and intelligent mind. This mind is the matrix of all matter.”

Other outstanding scientists have had similar insights into the true nature of Reality: Erwin Schrödinger (Nobel Physics Prize 1933): “Consciousness is that by which the world first becomes manifest, by which . . . it first becomes present: that the world consists of the elements of consciousness . . . their multiplicity [of minds] is only apparent, in truth there is only one mind . . . . Mind is always now. There is really no before or after for mind . . . Mind has erected the objective outside world . . . out of its own stuff.” (Schrödinger 1958)

Louis de Broglie (Nobel Physics Prize 1939): “In space-time, everything which for each of us constitutes the past, the present and the future is given en bloc . . . each observer, as his or her time passes, discovers, so to speak, new slices of space-time which appear to him or her as successive aspects of the material world, though in reality the ensemble of events constituting space-time exists prior to his or her knowledge of it.” (de Broglie 1959)

Albert Einstein (Nobel Physics Prize 1921): “For us convinced physicists, the distinction between past, present and future is only a stubbornly persistent illusion . . . time is not at all what it seems. It does not flow in only one direction, and the future exists simultaneously with the past.” (Einstein 1955)

Sir James Jeans: “The universe begins to look more like a great thought than like a great machine . . . The old dualism of mind and matter seems likely to disappear . . . through substantial matter resolving itself into a creation and manifestation of mind.” (Jeans 1930) . . . This brings us very near to those philosophical systems which regard the universe as a thought in the mind of its Creator, thereby reducing all discussion of material creation to futility”. (Jeans 1931)

Sir Arthur Eddington: “The stuff of the world is mind-stuff . . . The realistic matter and fields of force of former physical theory are altogether irrelevant—except in so far as the mind-stuff has itself spun these imaginings . . . It is difficult for a physicist to accept the view that the substratum of everything is of a mental character. But no one can deny that mind is the first and most direct thing in our experience, and all else is remote inference . . . Recognizing that the physical world is entirely abstract and without ‘actuality’ apart from its linkage to consciousness, we restore consciousness to the fundamental position . . . The idea of a universal mind or Logos would be, I think, a fairly plausible inference from the present state of scientific theory”. (Eddington 1930)

As Arthur Koestler has pointed out, “Since the concept of matter itself has been dematerialised by the physicists, materialism can no longer claim to be a scientific philosophy.” (Koestler, 1975) It follows that belief in the independent reality of something called “matter” may be a fallacy, based on an unproved and unprovable assumption that has hobbled and warped scientific thinking for centuries.

Within the obvious unity and wholeness of existence, materialist so-called philosophers, following Descartes, have gratuitously divided existence into a “material” world of “extended physical objects” and a “conceptual” world of “mental objects”, i.e., thoughts, feelings and beliefs. This doctrine has been widely accepted for the past 3½ centuries, by modern, but pre-Quantum scientists, resulting in their adoption of a reductionist, dualist materialism, which stubbornly persists, although this position has already been thoroughly undermined by the implications of their own research. It is known that consciousness and its products are all that we ever experience, and that Consciousness is clearly primal and ubiquitous, a fact which is coming increasingly to be recognized by the most advanced scientists themselves. The new way of perceiving the world is fully consistent with ancient wisdom, which declares that All that any individual knows is known only in consciousness; that the so-called “material” world is known only as a form of consciousness; that All is consciousness, so far as one knows, or can ever know According to the mentalist view, the universe is the manifestation in time and space of One Infinite Superconscious Being. It is by the present invention postulated that this Cosmic Mind, to which the individual's conscious and unconscious mind are essentially connected, contains all knowledge of all creatures and events, past, present and future, in a timeless NOW. In relation to the individual, it contains, inter alia, his or her complete incarnational history, past and future. The immediate purpose of the cards is to enable the user to gain direct access to this history. Their ultimate purpose is to help the user to achieve direct insight into reality, i.e., the perception that, in essence, the individual and the universal mind are one.

### “REINCARNATION”—REFERENCES

de Broglie, Louis (1959) “A General Survey of the Scientific Work of Albert Einstein”. In Schillp, Paul Arthur (Ed). Albert Einstein Philosopher-Scientist, N.Y., Evanston & London, Harper & Row, Harper Torchbook edition.
Eddington, Sir Arthur (1930) The Nature of the Physical World, N.Y. Macmillan/Cambridge University Press
Einstein, Albert (1955) Correspondence with Michelangelo Besso 1903-1955. P. Speziali (Ed) Hermann, Paris 1972. Quoted in Coveney, Peter & Roger Highfield. The Arrow of Time, London, Flamingo 1991.
Jeans, Sir James (1931), The Universe Around Us, N.Y. Macmillan/Cambridge University Press
Jeans, Sir James (1930), The Mysterious Universe, N.Y. Macmillan/Cambridge University Press
Koestler, Arthur (1975), “Order from Disorder”. In Hardy, Alister, Robert Harvie & Arthur
Koestler, The Challenge of Chance, NY Random House/First Vintage Books Edition
Schrödinger, Erwin (1958), What is Life?, Cambridge University Press
Stevenson, Ian (1997) Where Reincarnation and Biology Intersect, Westport, Conn., Praeger*
Stevenson, Ian (1966) Twenty Cases Suggestive of Reincarnation, Charlottesville, U of Virginia Press
Stevenson, Ian (1987) Children who Remember Past Lives, Charlottesville, U of Virginia Press
Weiss, Brian L. (1988) Many Lives, Many Masters, NY Simon & Schuster, “Fireside” Books
   * This most important, 200-page work condenses a much longer one entitled Reincarnation and Biology: A Contribution to the Etiology of Birthmarks and Birth Defects, a medical monograph with extensive documentation, references, numerous tables and many footnotes. Chapters in this abbreviated scholarly work cover such topics as:

“Birthmarks Corresponding to Wounds Verified by Informants” Memories (Ch. 5); “Birthmarks Corresponding to Wounds Verified by Medical Records” (Ch. 6); “Birthmarks Corresponding to Surgical Wounds and other Skin Lesions on Deceased Persons” (Ch. 7); “Birthmarks Corresponding to other Types of Wounds or Marks on Deceased Persons” (CH. 8); “Nevi (moles) Corresponding to Wounds or Other Marks on Deceased Persons” (Ch. 9); “Some Correlates of Birthmarks Attributed to Previous Lives” (Ch. 14); “The Interpretations of Birthmarks Related to Previous Lives” (Ch. 15); “Internal Diseases Related to Previous Lives” (Ch. 21); “Abnormalities of Pigmentation that may Derive from Previous Lives” (Ch. 22); “Physiques, Postures, Gestures and Other Involuntary Movements Related to Previous Lives” (Ch. 23); etc.

“Reincarnation”: Recommended Reading

1. Andrews, Ted, How to Uncover Your Past Lives, St. Paul Mn, Llewellyn 1992
2. Bernstein, Morey, The Search for Bridey Murphy, NY Doubleday 1950. Efforts to “debunk” this case have been refuted by Dr. C. J. Ducasse, writing in item (9) below
3. Cerminara, Dr. Gina, Many Mansions, NY, William Sloane Assoc. 1950. A psychologist examines the philosophy underlying past life research, karma and health
4. Cerminara, Dr. Gina, The World Within, NY, William Sloane Assoc. 1957. A psychologist studies the implications of reincarnation. How does it change one's attitude to life? The body? Sex? Race? Religion?
5. Cerminara, Dr. Gina, Many Lives, Many Loves, NY, William Sloane Assoc. 1963. An eloquent and inspiring treatment of love from the reincarnation perspective.
6. Cockell, Jenny, Across Time and Death—A Mother's Search for her Past-Life Children, NY, Fireside Books, 1994. The true verified story of how Jenny Cockell actually found the still-living children that she had left behind in Ireland in a previous incarnation.
7. Cockell, Jenny, Past Lives, Future Lives, NY, Fireside Books, 1996. Records her “memories” of both past and future incarnations.
8. Cranston, Sylvia & Carey Williams, Reincarnation—A New Horizon in Science, Religion and Society, NY, Julian Press (Crown Pubs) 1984. A wide-ranging survey, bringing together the work of scientists, theologians, social historians, psychologists. A most comprehensive and practical book.
9. Ebon, Martin (Ed), Reincarnation in the Twentieth Century, NY, New American Library 1970. Records a number of documented case histories of reincarnation.
10. Finkelstein, Dr. Adrian, Your Past Lives and the Healing Process, Farmingdale NY, Coleman Publishing 1985. A psychiatrist looks at reincarnation and spiritual healing.
11. Fiore, Dr. Edith, You Have Been Here Before, NY, Coward, McCann & Geoghegan 1978. A clinical psychologist presents case histories of reincarnation from her practice, with much about curing phobias and physical disabilities carried over from previous incarnations.
12. Holzer, Hans, Born Again—The Truth About Reincarnation. Garden City, NY, Doubleday, 1970.
13. McClain, Florence W., A Practical Guide to Past Life Regression, St. Paul Minn., Llewellyn, 1985. A useful practical manual for the aspiring reincarnation researcher.
14. Snow, Dr. Chet B., Mass Dreams of the Future, Crest Park Calif., Deep Forest Press, 1989. A startling examination of future incarnations. A superb merging of age-old traditions with the meticulous research of the late Dr. Helen Wambach (see item 21 below) on future events.
15. Stevenson, Dr. Ian, Twenty Cases Suggestive of Reincarnation, Charlottesville, U. of Virginia Press, 1966. Dr: Stevenson is former Carlson Professor of Psychiatry at the University of Virginia Medical School and former chairman of the Department. He has over 2000 carefully investigated cases of reincarnation in his files. His book Where Reincarnation and Biology Intersect (see item 17 below) has put the final nail in the coffin of the sceptics, deniers and doubters of the reality of the reincarnation phenomenon.
16. Stevenson, Dr. Ian, Children Who Remember Past Lives, Charlottesville, U. of Virginia Press, 1987/1992. Dr. Stevenson provides case studies of children's reincarnational memories.
17. Stevenson, Dr. Ian, Where Reincarnation and Biology Intersect, Westport Conn., Praeger, 1997. This most important work is a condensation of a much longer one titled Reincarnation and Biology: A Contribution to the Etiology of Birthmarks and Birth Defects, a medical monograph with extensive documentation, references, tables, footnotes and photographic evidence (as also in the condensed version). Individual chapters in this abbreviated, scholarly work cover such topics as “Birthmarks Corresponding to Wounds Verified by Informants” “Memories” (Ch. 5)); “Birthmarks Corresponding to Wounds Verified by Medical Records” (Ch. 6);

“Birthmarks Corresponding to Surgical Wounds and other Skin Lesions on Deceased Persons” (Ch. 7); “Birthmarks Corresponding to other Types of Wounds or Marks on Deceased Persons” (CH. 8); “Nevi (moles) Corresponding to Wounds or Other Marks on Deceased Persons” (Ch. 9); “Some Correlates of Birthmarks Attributed to Previous Lives” (Ch. 14); “The Interpretations of Birthmarks Related to Previous Lives” (Ch. 15); “Internal Diseases Related to Previous Lives” (Ch. 21); “Abnormalities of Pigmentation that may Derive from Previous Lives” (Ch. 22); “Physiques, Postures, Gestures and Other Involuntary Movements Related to Previous Lives” (Ch. 23); etc. This is the ideal book for anyone who still doubts the truth of the reincarnation phenomenon.
18. Sutphen, Dick, You Were Born to be Together, NY, Pocket Books, 1976. Prominent psychic and past-life researcher examines how love and karma reunite the same couples life after life. Case histories.
19. Sutphen, Dick, Past Lives, Future Loves, NY, Pocket Books, 1978.
20. Talbot, Michael, Your Past Lives—A Reincarnation Handbook, NY, Ballantine, 1987. An explicit, step-by-step guide for remembering and exploring past lives. Also recounts his own spontaneous memories of previous incarnations.
21. Wambach, Dr. Helen, Reliving Past Lives, NY, Harper & Row (Barnes & Noble), 1984. Clinical psychologist presents the evidence of over 1000 hypnosis-induced past life recalls.
22. Weiss, Dr. Brian L., Many Lives, Many Masters, NY, Fireside, 1988. Psychiatrist recounts the case history of a patient who recalled past-life traumas that seemed to hold the key to her recurring nightmares and anxiety attacks. Using past-life therapy, Dr. Weiss was able to cure his patient. Dr. Weiss has written several other books on the subject of his experiences with patients involving the cure of past-life-generated phobias.
23. Williston, Dr. Glenn and Judith Johnstone, Discovering Your Past Lives, London, Harper Collins, 1998. Dr. Williston is a clinical psychologist who has successfully developed the protocol for regression therapy. This book contains many insights into the greater self and its incarnate manifestations; a treatise on spiritual growth through a knowledge of past lifetimes.

It will be understood that the recollection of past experiences and lives is secondary to the increased self-awareness and growth that can result from correct and diligent use of the cards and methods of the present invention. As such, then, the spirit of the present invention may be said to be grounded in the present.

The embodiments of the invention in which an exclusive property or privilege is claimed are defined as follows:

1. Apparatus for use in personal awareness training, comprising:
a plurality of coded card sets, each card set having a generic indicia associated with it, the cards in a set having a common theme.

2. Apparatus as claimed in claim 1, wherein said indicia is selected from the group consisting of colours, words, symbols, or graphical images.

3. Apparatus as claimed in claim 1, wherein the themes of said card sets are themes relevant to life experiences.

4. Apparatus as claimed in claim 1, wherein each set has from 9 to 17 cards.

5. Apparatus as claimed in claim 2, wherein each set has from 9 to 17 cards.

6. Apparatus as claimed in claim 3, wherein each set has from 9 to 17 cards.
